(19) United States
(12) Patent Application Publication
(10) Pub. No.: US 2005/0195352 A1
(43) Pub. Date: Sep. 8, 2005

(54) Liquid crystal display device

(75) Inventors: Masumi Kubo, Ikoma-shi (JP); Akihiro Yamamoto, Yamatokoriyama-shi (JP); Hiroyuki Ohgami, Shiki-gun (JP); Takashi Ochi, Tenri-shi (JP); Ryuichi Yokoyama, Kameyama-shi (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/074,013

(22) Filed: Mar. 8, 2005

(30) Foreign Application Priority Data
Mar. 8, 2004 (JP) 2004-064223

(51) Int. Cl. G02F 1/1343

(52) U.S. Cl. 349/139

(57) ABSTRACT

The liquid crystal display device of the invention has a plurality of pixels each having a first electrode, a second electrode facing the first electrode, and a vertically aligned liquid crystal layer placed between the first and second electrodes. The device includes: ribs in a stripe shape having a first width placed in the first electrode side of the liquid crystal layer; slits in a stripe shape having a second width placed in the second electrode side of the liquid crystal layer; and liquid crystal regions having a third width defined between the ribs and the slits. The third width is in a range between 2 μm and 14 μm, and the ratio of the third width to the second width is in a range between 1.0 and less than 1.5.

### BACKGROUND OF THE INVENTION

1. Field of the Invention

The present invention relates to a liquid crystal display device and a driving method for the same, and more particularly relates to a liquid crystal display device suitably used for display of moving images and a driving method for the same.

2. Description of the Related Art

In recent years, liquid crystal display devices (LCDs) have increasingly come into widespread use. Among various types of LCDs, mainstream has been a TN LCD in which a nematic liquid crystal material having positive dielectric anisotropy is twisted. The TN LCD however has a problem of being large in viewing angle dependence that results from the alignment of liquid crystal molecules.

To improve the viewing angle dependence, alignment-divided vertical alignment LCDs have been developed, and use of these LCDs is expanding. For example, Japanese Patent Gazette No. 2947350 (Literature 1) discloses an MVA LCD as one of the alignment-divided vertical alignment LCDs. The MVA LCD, which includes a vertically aligned liquid crystal layer placed between a pair of electrodes to present display in the normally black (NB) mode, is provided with domain regulating means (for example, slits or protrusions) to enable liquid crystal molecules in each pixel to fall (tilt) in a plurality of different directions during application of a voltage.

Recently, needs for displaying moving image information have rapidly increased, not only in LCD TVs, but also in PC monitors and portable terminal equipment (such as mobile phones and PDAs). To display moving images with high definition on LCDs, it is necessary to shorten the response time (increase the response speed) of the liquid crystal layer, so that a predetermined grayscale level can be reached within one vertical scanning period (typically, one frame).

As for the MVA LCD, Literature 1 mentioned above, for example, discloses that the black-to-white response time can be shortened to 10 msec or less. Literature 1 also describes that regions different in the distance between protrusions are provided in each pixel to give regions different in response speed, to thereby attain improvement in apparent response speed without reducing the aperture ratio (see FIGS. 107 to 110 of Literature 1, for example).

As a driving method that can improve the response characteristic of LCDs, known is a method in which a voltage higher than a voltage (grayscale voltage) corresponding to the grayscale level to be displayed (this voltage is called an “overshoot (OS) voltage”) is applied (this method is called “overshoot (OS) driving”). With application of an OS voltage, the response characteristic in grayscale display can be improved. The “overshoot voltage” and the “overshoot driving” are also called an “overdrive voltage” and “overdrive driving”, respectively, in some cases.

For example, Japanese Laid-Open Patent Publication No. 2000-231091 (Literature 2) discloses an MVA LCD adopting the OS driving. Literature 2 however describes that an OS voltage should not be applied when a shift is made from the black display state to a high-luminance grayscale display state (see FIG. 8 of Literature 2, for example). The reason is described as that the transmittance will be overshot if an OS voltage (voltage 1.25 times as high as that for giving the target transmittance) is applied at a shift from the black display state to a high-luminance grayscale display state as is applied at a shift from the black display state to a low-luminance grayscale display state or to the white display state.

However, as a result of examinations done by the inventors of the present invention, it has been found that a new problem arises when the OS driving is adopted for alignment-divided vertical alignment LCDs such as the MVA LCD described above. This problem will be described with reference to FIGS. 17A and 17B.

FIGS. 17A and 17B are views diagrammatically showing the state of display observed when a square 92 of a certain grayscale level (for example, level 32/255) is moved in a black background 90 (for example, level 0), in the cases of driving a conventional MVA LCD by a normal driving method (FIG. 17A) and driving the same by the OS driving (FIG. 17B). Note that the “level 32/255” is a grayscale level giving a luminance of (32/255)^{2.2} with respect to the luminance in black display (during application of V0) as 0 and the luminance in white display (during application of V255) as 1 when the grayscale display is set as γ^{2.2}. The grayscale voltage giving this luminance is denoted by V32.

When no OS driving is adopted, the response speed of the alignment-divided vertical alignment LCD is low. Therefore, as diagrammatically shown in FIG. 17A, an edge 92a of the square 92 located downstream the moving direction may not be observed clearly in some cases. When the OS driving is adopted, the response speed is improved, and thus as diagrammatically shown in FIG. 17B, the edge 92a is observed clearly. However, a new phenomenon arises in some cases, in which a dark belt 92b is observed at a position of the square a little apart from the edge 92a.

The present inventors have examined the cause of the above problem in various ways, and found that the above phenomenon is a new problem that has never occurred as long as the OS driving is adopted for conventional TN LCDs, and results from the alignment division done with the alignment regulating means (domain regulating means) placed linearly (in a stripe shape) in each pixel in alignment-divided vertical alignment LCDs.

In view of the above, a main object of the present invention is providing an alignment-divided vertical alignment LCD permitting high-definition moving image display.

### SUMMARY OF THE INVENTION

The liquid crystal display device of the present invention includes a plurality of pixels each having a first electrode, a second electrode facing the first electrode, and a vertically aligned liquid crystal layer placed between the first and second electrodes, the device including: ribs in a stripe shape having a first width placed in the first electrode side of the liquid crystal layer; slits in a stripe shape having a second width placed in the second electrode side of the liquid crystal layer; and liquid crystal regions having a third width defined between the ribs and the slits, wherein the third width is in a range between 2 μm and 14 μm, and the ratio of the third width to the second width is in a range between 1.0 and less than 1.5.

In one embodiment, the ratio of the second width to the thickness of the liquid crystal layer is 4 or more.

In another embodiment, the third width is 12 μm or less.

In yet another embodiment, the third width is 8 μm or less.

In yet another embodiment, the first width is in a range between 4 μm and 20 μm, and the second width is in a range between 4 μm and 20 μm.

In yet another embodiment, the thickness of the liquid crystal layer is less than 3 μm.

In yet another embodiment, the device includes a pair of polarizing plates placed to face each other with the liquid crystal layer therebetween, transmission axes of the pair of polarizing plates are orthogonal to each other, one of the transmission axes extends in a horizontal direction in the display plane, and the ribs and the slits are placed to extend in a direction about 45° from the one of the transmission axes.

In yet another embodiment, the device further includes a drive circuit capable of applying an overshoot voltage higher than a grayscale voltage determined in advance to correspond to a predetermined grayscale.

The electronic equipment of the present invention includes any of the liquid crystal display device described above. Preferably, the electronic equipment further includes a circuit for receiving television broadcast.

According to the present invention, an alignment-divided vertical alignment LCD that can present high-definition moving image display when OS driving is adopted is provided. In addition, in the alignment-divided vertical alignment LCD of the present invention, reduction in display luminance that may result from the improvement in moving image display performance can be suppressed. The LCD of the present invention is suitably usable as an LCD TV by being provided with a circuit for receiving television broadcast. Also, the LCD of the present invention is suitably applicable to electronic equipment used for display of moving images, such as personal computers and PDAs.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a cross-sectional view diagrammatically showing a basic configuration of an MVA LCD of an embodiment of the present invention.

FIG. 2 is a partial cross-sectional view diagrammatically showing the sectional structure of an LCD 100 of an embodiment of the present invention.

FIG. 3 is a diagrammatic plan view of a pixel portion 10a of the LCD 100.

FIG. 4 is a view showing the results of measurement of changes in luminance distribution in a pixel of the LCD 100 observed when OS driving is done.

FIGS. 5A and 5B are graphs showing changes in transmittance with time observed when a conventional MVA LCD is subjected to OS driving, measured at 25° C. and 5° C., respectively.

FIG. 6 is a graph showing the minimum of the transmittance taken after application of an OS voltage, obtained as a result of measurement of changes in transmittance with time shown in FIGS. 5A and 5B, for various LCDs with different LC region widths W3.

FIGS. 7A and 7B are graphs showing the results of subjective evaluation of problems caused by angular response.

FIG. 8 is a graph showing the relationship between the LC region width W3 and the width of a third LC portion R3.

FIG. 9 is a graph re-plotting the values in the graph of FIG. 6 with respect to the width of the third LC portion R3.

FIGS. 10A to 10C are graphs of which the x-axis represents the LC region width W3/slit width W2, and the y-axis represents the transmission efficiency (FIG. 10A), the aperture ratio (FIG. 10B) and the transmittance (FIG. 10C), respectively.

FIGS. 11A through 11C are graphs of which the x-axis represents the slit width W2/thickness d of the liquid crystal layer, and the y-axis represents the transmission efficiency (FIG. 11A), the aperture ratio (FIG. 11B) and the transmittance (FIG. 1C), respectively.

FIG. 12 is a view diagrammatically showing the alignment of liquid crystal molecules 13a in a portion of a liquid crystal region 13A near a slit 22.

FIGS. 13A and 13B are diagrammatic views for demonstrating the influence of an interlayer insulating film of an LCD on the alignment of liquid crystal molecules.

FIG. 14A is a graph showing the relationship between the product of the LC region width W3 and the thickness d of the liquid crystal layer and the transmittance turnaround time, and FIG. 14B is a view for definition of the transmittance turnaround time.

FIGS. 15A through 15C are graphs showing changes in transmittance with time observed when the LCD of the embodiment of the present invention and a conventional LCD are subjected to OS driving.

FIG. 16 is a graph showing the set values of OS voltages used to obtain the changes in transmittance shown in FIG. 14.

FIGS. 17A and 17B are diagrammatic views for demonstrating a problem related to moving image display in a MVA LCD.

### DETAILED DESCRIPTION OF PREFERRED EMBODIMENTS

Hereinafter, LCDs of embodiments of the present invention and driving methods for the LCDs will be described with reference to the relevant drawings.

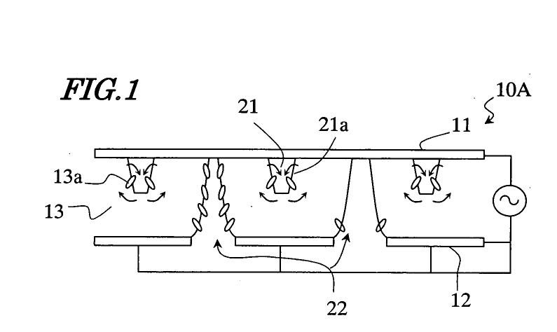

First, a basic configuration of an alignment-divided vertical alignment LCD of an embodiment of the present invention will be described with reference to FIG. 1. The alignment-divided vertical alignment LCD exemplified herein is an MVA LCD having stripe-shaped ribs and stripe-shaped slits.

The LCD of an embodiment of the present invention includes a plurality of pixels each having a first electrode 11, a second electrode 12 facing the first electrode 11, and a vertically aligned liquid crystal layer 13 placed between the first electrode 11 and the second electrode 12. The vertically aligned liquid crystal layer 13 includes liquid crystal molecules having negative dielectric anisotropy that are aligned roughly vertically (for example, at an angle in the range between 87° and 90°) with respect to the plane of the first and second electrodes 11 and 12 during non-voltage application. Typically, this alignment is attained by providing a vertical alignment film (not shown) on each of the surfaces of the first and second electrodes 11 and 12 facing the liquid crystal layer 13. Ribs (protrusions) and the like may be provided as alignment regulating means. In this case, liquid crystal molecules are aligned to roughly vertically with respect to the surfaces of the ribs and the like facing the liquid crystal layer.

Ribs 21 are provided in the first electrode 11 side of the liquid crystal layer 13, while slits 22 are provided in the second electrode 12 side of the liquid crystal layer 13. In each of liquid crystal regions defined between the ribs 21 and the slits 22, liquid crystal molecules 13a are under alignment regulating force applied from the rib 21 and the slit 22. Once a voltage is applied between the first and second electrodes 11 and 12, the liquid crystal molecules 13a fall (tilt) in the directions shown by the arrows in FIG. 1. That is, in each of the liquid crystal regions, liquid crystal molecules fall in a uniform direction. Such liquid crystal regions therefore can be regarded as domains.

The ribs 21 and the slits 22 (hereinafter, these may be collectively called “alignment regulating means” in some cases) are placed in a stripe shape in each pixel. FIG. 1 is a cross-sectional view taken orthogonal to the extension of the stripe-shaped alignment regulating means. Liquid crystal regions (domains) in which liquid crystal molecules 13a fall in directions different by 180° from each other are formed on both sides of each alignment regulating means.

Specifically, an LCD 10A shown in FIG. 1A has ribs 21 on the first electrode 11 and slits (openings) 22 in the second electrode 12. The ribs 21 and the slits 22 extend in a stripe shape. The ribs 21 serve to align liquid crystal molecules 13a roughly vertically with respect to the side faces of the ribs 21, so that the liquid crystal molecules 13a are aligned in a direction orthogonal to the extension of the ribs 21. The slits 22 serve to generate an inclined electric field in areas of the liquid crystal layer 13 near the edges of the slits 22 when a potential difference is given between the first and second electrodes 11 and 12, so that the liquid crystal molecules 13a are aligned in a direction orthogonal to the extension of the slits 22. The ribs 21 and the slits 22 are placed in parallel with each other with a predetermined spacing therebetween, and liquid crystal regions (domains) are formed between the ribs 21 and the slits 22 adjacent to each other.

The first and second electrodes 11 and 12 may be electrodes facing each other with the liquid crystal layer 13 therebetween. Typically, one electrode is a counter electrode, and the other is a pixel electrode. Hereinafter, an embodiment of the present invention will be described taking, as an example, an LCD having a counter electrode as the first electrode 11 and a pixel electrode as the second electrode 12. The LCD 10A shown in FIG. 1A is advantageous in that increase in the number of fabrication steps can be minimized. That is, no additional step is required in forming slits in the pixel electrode. As for the counter electrode, increase in the number of steps is smaller in placing ribs thereon than in forming slits therein.

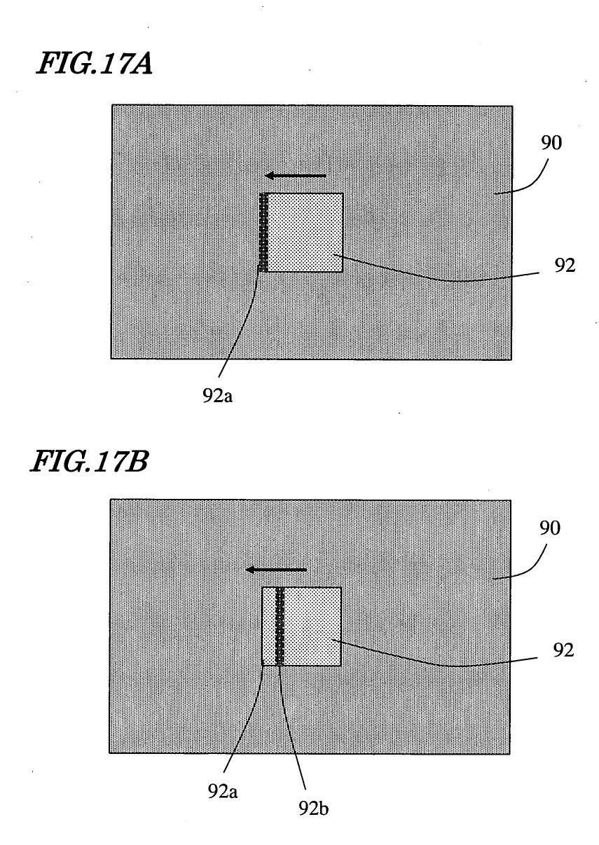

The present inventors have found, from examinations in various ways, that the problem discussed above with reference to FIG. 17B results from the alignment division done with the ribs and the slits placed in pixels in a stripe shape, and that occurrence of this problem can be suppressed by limiting the width of liquid crystal regions defined between the ribs and the slits to 14 μm or less. Hereinafter, the cause of this problem and effects of the LCD of the present invention will be described in detail.

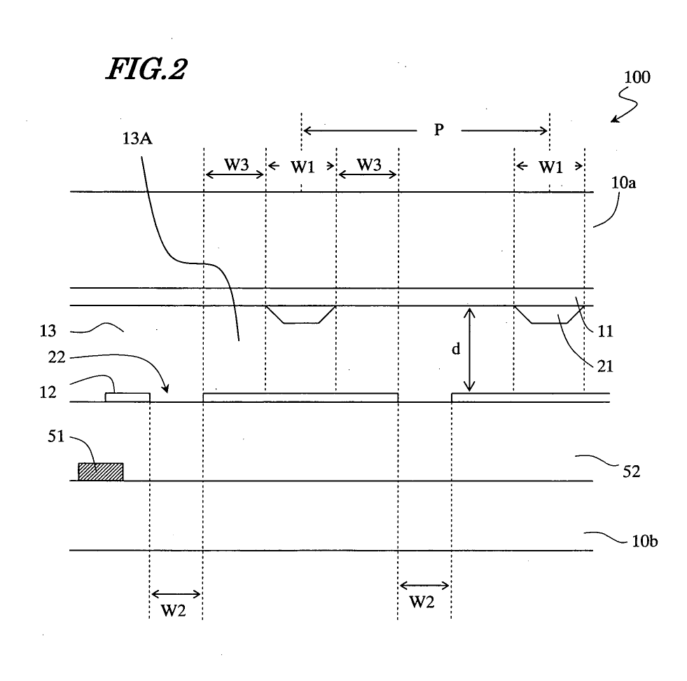

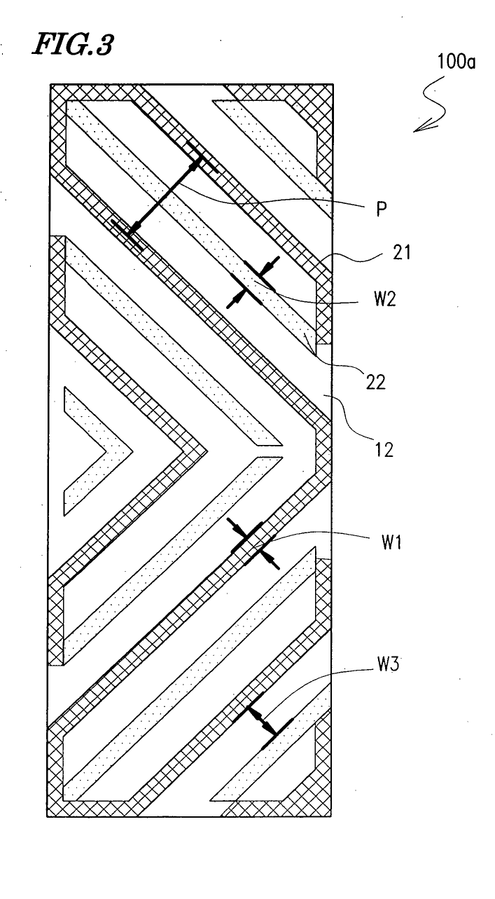

First, the basic configuration of the LCD of the embodiment of the present invention will be described with reference to FIGS. 2 and 3. FIG. 2 is a partial cross-sectional view diagrammatically showing the sectional structure of an LCD 100, and FIG. 3 is a plan view of a pixel portion 110a of the LCD 100. The LCD 100 is substantially the same in basic configuration as the LCD 10A shown in FIG. 1. Common components are therefore denoted by the same reference numerals.

The LCD 100 has a vertically aligned liquid crystal layer 13 between a first substrate (for example, glass substrate) 10a and a second substrate (for example, glass substrate) 10b. A counter electrode 11 is formed on the surface of the first substrate 10a facing the liquid crystal layer 13, and ribs 21 are formed on the counter electrode 11. A vertical alignment film (not shown) is formed covering substantially the entire surface of the counter electrode 11 including the ribs 21 facing the liquid crystal layer 13. The ribs 21 extend in a stripe shape as shown in FIG. 3 so that the adjacent ribs 21 are in parallel with each other with a uniform spacing (pitch) P therebetween. The width W1 of the ribs 21 (width in the direction orthogonal to the extension) is also uniform.

Gate bus lines (scanning lines) and source bus lines (signal lines) 51, as well as TFTs (not shown), are formed on the surface of the second substrate lob facing the liquid crystal layer 13, and an interlayer insulating film 52 is formed to cover these components. A pixel electrode 12 is formed on the interlayer insulating film 52. The interlayer insulating film 52, which has a flat surface, is made of a transparent resin film having a thickness in the range between 1.5 μm and 3.5 μm, to thereby enable overlap placement of the pixel electrode 12 with the gate bus lines and/or the source bus lines. This is advantageous in improving the aperture ratio.

Stripe-shaped slits 22 are formed in the pixel electrode 12, and a vertical alignment film (not shown) is formed covering substantially the entire surface of the pixel electrode 12 including the slits 22. As shown in FIG. 3, the slits 22 extend in a stripe shape in parallel with each other so as to roughly bisect the spacing between the adjacent ribs 21. The width W2 of the slits 22 (width in the direction orthogonal to the extension) is uniform. The shapes and arrangements of the slits and ribs described above may deviate from the respective design values in some cases due to a variation in fabrication process, misalignment in bonding of the substrates and the like. The above description does not exclude these deviations.

A stripe-shaped liquid crystal region 13A having a width W3 is defined between the adjacent stripe-shaped rib 21 and slit 22 extending in parallel with each other. In the liquid crystal region 13A, the alignment direction is regulated with the rib 21 and the slit 22 placed on both sides of the region. Such liquid crystal regions (domains) are formed on the opposite sides of each of the ribs 21 and the slits 22, in which liquid crystal molecules 13a tilt in the directions different by 180° from each other. As shown in FIG. 3, in the LCD 100, the ribs 21 and the slits 22 extend in two directions different by 90° from each other, and each pixel portion 10a has four types of liquid crystal regions 13A different in the alignment direction of liquid crystal molecules 13a by 90° from one another. Although the arrangement of the ribs 21 and the slits 22 is not limited to the example described above, this arrangement ensures good viewing angle characteristic.

A pair of polarizing plates (not shown) are placed on the outer surfaces of the first and second substrates 10a and lob so that the transmission axes thereof are roughly orthogonal to each other (in the crossed-Nicols state). If the polarizing plates are placed so that the transmission axes thereof form 45° with the alignment directions of all the four types of liquid crystal layers 13A that are different by 90° from one another, a change in retardation with the liquid crystal regions 13A can be used most efficiently. That is, the polarizing plates should preferably be placed so that the transmission axes thereof form roughly 45° with the directions of extension of the ribs 21 and the slits 22. In display devices in which observation is often moved in a direction horizontal to the display plane, such as TVs, the transmission axis of one of the polarizing plates preferably extends in a horizontal direction in the display plane for suppression of the viewing angle dependence of the display quality.

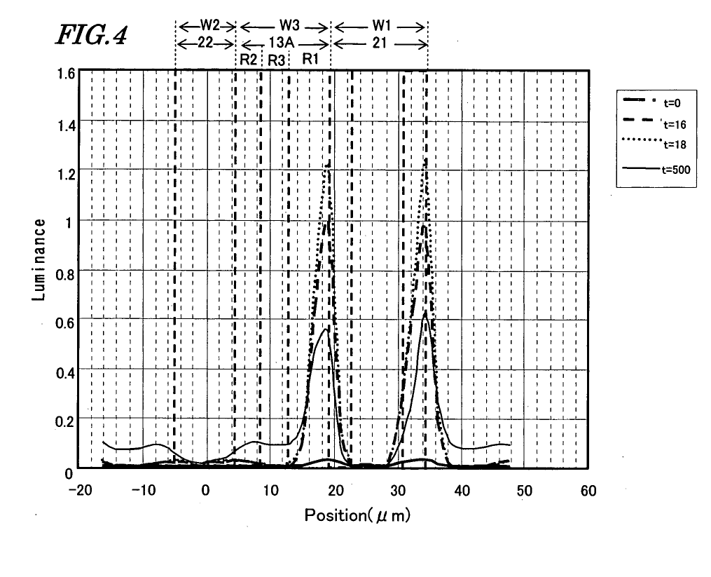

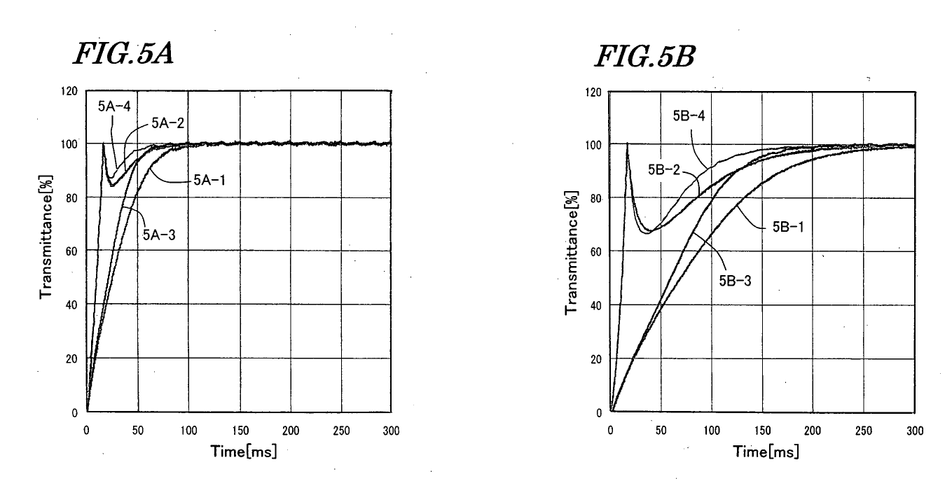

The MVA LCD 100 having the configuration described above can present display excellent in viewing angle characteristic. When OS driving is adopted for this LCD, however, the phenomenon shown in FIG. 17B may occur. This phenomenon will be described in detail with reference to FIGS. 4 and 5.

A change in luminance distribution in a pixel of the LCD 100 observed in OS driving was measured with a high-speed camera. FIG. 4 is a view showing the results of this measurement. Note that the measurement results at 5° C. are shown for easy understanding. The x-axis of this graph represents the position in the direction orthogonal to the extension of the ribs 21 and the slits 22, in which the center in the width direction of one of the adjacent slits 22 is determined as the origin. The luminance distribution was measured at 0 msec (V0-applied state; at this time, OSV32 is applied) and at 16 msec, 18 msec and 500 msec from the application of OSV32. Note that after the application of OSV32 in one vertical scanning period (one frame=16.7 msec in this example) V32 was continuously applied in the subsequent vertical scanning periods until the lapse of 500 msec from the application of OSV32. The y-axis of this graph represents the relative luminance determined with respect to the luminance of the light-shaded region as 0 and the luminance of a third LC portion R3 to be described later obtained after 500 msec as 0.1.

Specific cell parameters of the LCD 100 used in the illustrated example are as follows. The thickness d of the liquid crystal layer is 3.9 μm, the inter-rib pitch P is 53 μm, the width W1 of the ribs 21 is 16 μm (including the width of the side faces 4 μm×2), the width W2 of the slits 22 is 10 μm, and the width W3 of the liquid crystal regions 13A is 13.5 μm. The black voltage (V0) is 1.2 V, the white voltage (V255) is 7.1 V, and the voltage (V32) and the OS voltage (OSV32) for grayscale level 32 (transmittance 1.04%) are 2.44 V and 2.67V, respectively, when the y value is 2.2. The OS voltage (OSV32) was set so that the entire pixel could give the luminance (transmittance) of grayscale level 32 in 16 msec after the black state (V0-applied state).

As is found from FIG. 4, in each liquid crystal region 13A, the luminance is high in a portion near the side face 21a of the rib 21 (this portion is called a “first LC portion R1”), and in this portion, the luminance decreases after reaching its maximum at 18 msec. On the contrary, in the remaining portion other than the first LC portion R1, the luminance monotonously increases with time, and the once-increased luminance will never be decreased. In each liquid crystal region 13A, also, a portion near the slit 22 (this portion is called a “second LC portion R2”) is higher in response speed than the portion in the center between the rib 21 and the slit 22 (this portion is called a “third LC portion R3”) because the former portion is under the influence of a tilt electric field generated near the slit 22. Thus, each stripe-shaped liquid crystal region 13A defined by the stripe-shaped rib 21 and slit 22 has three LC portions (R1, R2 and R3) different in response speed from one another.

Change of the entire transmittance of the pixel portion 100a with time is then described with reference to FIGS. 5A and 5B. FIGS. 5A and 5B show the results measured at 25° C. and 5° C., respectively, in which the y-axis represents the transmittance determined with respect to the transmittance of grayscale level 0 as 0% and the transmittance of grayscale level 32 as 100%.

Curves 5A-1 and 5A-2 in FIG. 5A represent the results obtained without OS driving and with OS driving, respectively, when the thickness d of the liquid crystal layer is 3.9 μm. Curves 5A-3 and 5A-4 represent the results obtained without OS driving and with OS driving, respectively, when the cell gap is 2.8 μm. Likewise, curves 5B-1 and 5B-2 in FIG. 5B represent the results obtained without OS driving and with OS driving, respectively, when the thickness d of the liquid crystal layer is 3.9 μm. Curves 5B-3 and 5B-4 represent the results obtained without OS driving and with OS driving, respectively, when the cell gap is 2.8 μm. As the liquid crystal material for the liquid crystal layer in any of the above cases, selected was a liquid crystal material having a rotational viscosity γ1 of about 140 mPa·s and a flow viscosity ν of about 20 mm²/s and giving a retardation (thickness d×birefringence Δn) of the liquid crystal layer of about 300 nm.

As is apparent from FIGS. 5A and 5B, at both temperatures of 25° C. and 5° C., the following phenomenon is observed when OS driving is done. That is, the transmittance once decreases after reaching a predetermined value (100%) within a vertical scanning period during which an OS voltage has been applied, and then gradually increases to finally reach the predetermined value again. This phenomenon having a minimum in the change of transmittance with time is called “horn response” in some cases.

From comparison between FIGS. 5A and 5B, it is found that the above phenomenon is more eminent at 5° C. at which the response speed of liquid crystal molecules is low. That is, the minimum in the change of transmittance with time is smaller and the time required to reach the predetermined transmittance value is longer. It is also found from FIGS. 5A and 5B that as the thickness d of the liquid crystal layer is greater, the response speed is lower, that is, the time period during which the transmittance is low is longer, at both temperatures. These tendencies correspond with the results of the visual observation shown in FIG. 17B.

From the above, it has been recognized that the dark belt 92b shown in FIG. 17B is observed because a minimum exists in the change of transmittance with time, and that the reason for the existence of a minimum in the change of transmittance with time is that the response speed greatly differs among the first, second and third LC portions R1, R2 and R3 described above with reference to FIG. 4. This phenomenon will be described in more detail with reference to FIG. 4 again.

Liquid crystal molecules in the first LC portion R1 located near the rib 21 are already in a tilted state under the influence of the side face 21a of the rib 21 when a voltage is applied, and thus the response speed of this portion is high. Once an OS voltage (OSV32), set to ensure the shift of the transmittance of the entire pixel from 0 to 32 in grayscale level within one frame period, is applied, the transmittance of the first LC portion R1 exceeds at least a transmittance value that is obtained when V32 is normally applied (transmittance value represented by the curve of t=500 msec in FIG. 4), and may even reach or be close to a transmittance value corresponding to the OS voltage (OSV32) in some cases. On the contrary, in the other portions (the second and third LC portions R2 and R3), the response speed is low, failing to reach the transmittance value corresponding to V32 within one frame period even when OSV32 is applied.

In the subsequent frame periods (t>16.7 msec) in which V32 is applied, the transmittance of the first LC portion R1 monotonously decreases to the transmittance value corresponding to V32. On the contrary, the transmittances of the second and third LC portions R2 and R3 monotonously increase to the transmittance value corresponding to V32.

Even when the transmittance of the entire pixel reaches the transmittance value corresponding to V32 within the frame period during which OSV32 is applied, this transmittance includes a component having an excessively high response speed (transmittance component exceeding the transmittance value corresponding to V32). Therefore, when the application of OSV32 is stopped and a predetermined grayscale voltage V32 is applied, the transmittance of the entire pixel temporarily decreases because the component having an excessively high response speed decreases to the predetermined transmittance at a rate higher than the rate at which components having a low response speed (transmittance components of the second and third LC portions R2 and R3) increases. Thereafter, with increase of the components having a low response speed, the transmittance of the entire pixel increases. This explains the details of the change of transmittance with time in the pixel portion shown in FIGS. 5A and 5B.

The OS driving is also applied to TN LCDs, but the horn response described above is not observed in TN LCDs. The reason is that, in TN LCDs, the alignment division is attained by regulating the alignment directions of liquid crystal molecules in respective liquid crystal regions (domains) with alignment films rubbed in different directions. Since the alignment regulating force is given to the entire of each liquid crystal region from a planar (two-dimensional) alignment film, no response speed distribution arises in each liquid crystal region. On the contrary, in MVA LCDs having stripe-shaped ribs and slits, the alignment division is made with the linear (one-dimensional) alignment regulating means (ribs and slits) provided. Therefore, portions having different response speeds are formed depending on, not only the difference in the alignment regulating force of the alignment regulating means, but also the distance from the alignment regulating means.

To find a configuration permitting suppression of the horn response characteristic, that is, the occurrence of the phenomenon that the transmittance has a minimum after application of an OS voltage described above, various MVA LCDs having the basic configuration shown in FIGS. 2 and 3 were fabricated by varying the cell parameters (the thickness d of the liquid crystal layer, the rib pitch P, the rib width W1, the slit width W2, the width W3 of the liquid crystal region, the rib height and the like), and the response characteristics of these LCDs were evaluated.

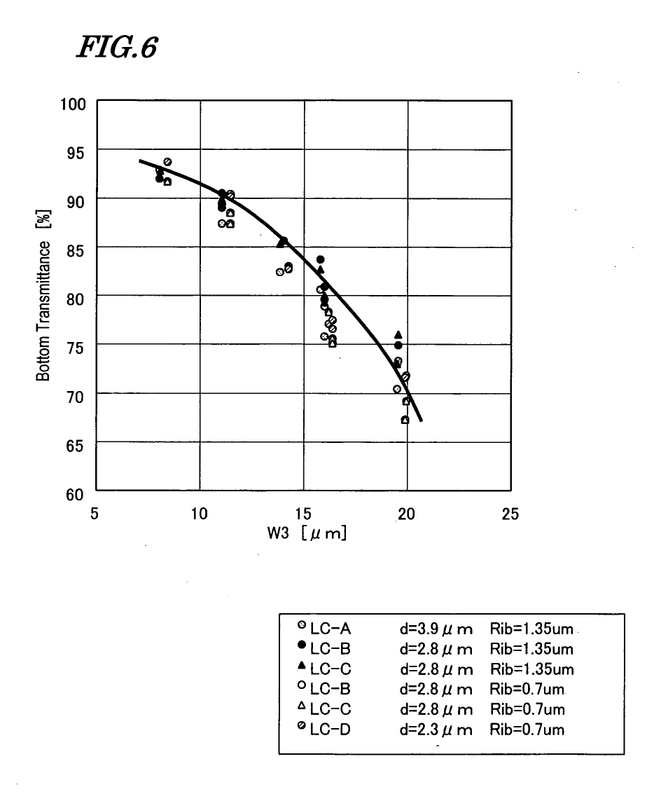

As a result, the followings were found. It was confirmed that the response speed increased by reducing the thickness d of the liquid crystal layer as described above with reference to FIGS. 5A and 5B. It was recognized that the response speed tended to somewhat increase by increasing the rib width W1 and the slit width W2. The response speed also somewhat increased by increasing the height of the ribs. However, these effects of improving the response speed by adjusting the rib width W1, the slit width W2 and the rib height were small. Contrarily, large improvement in response characteristic was attained by reducing the width W3 of the liquid crystal region (LC region width W3). FIG. 6 shows part of the above results.

FIG. 6 is a view showing the minimum of the transmittance after application of an OS voltage, observed in the measurement of the change of transmittance with time shown in FIG. 5A, obtained by varying the LC region width W3 for six types of LCDs having cell configurations different in the thickness d of the liquid crystal layer and rib height. In this measurement, the transmittance of grayscale level 32 is determined as 100%. The minimum of the transmittance (also called “minimum transmittance” in some cases) was roughly uniform irrespective of the thickness d of the liquid crystal layer. The rib width W1 and the slit width W2 of the LCDs used in this measurement were in the range between about 5 μm and about 20 μm, and the rib pitch P was in the range between about 25 μm and about 58 μm. The measurement results shown in FIG. 6 were obtained at 25° C.

From FIG. 6, the followings are found. First, irrespective of the six types (more types if differences in rib width W1 and slit width W2 are counted) of cell configurations, a strong correlation exists between the LC region width W3 and the minimum transmittance. Secondly, the minimum transmittance increases roughly monotonously, that is, the response characteristic is improved, by reducing the LC region width W3.

From the results of FIG. 6, it is recognized that the minimum transmittance can be increased to 85% or more by reducing the LC region width W3 to about 14 μm or less, and even to 90% or more by reducing the width W3 to about 12 μm or less. The dark belt 92b shown in FIG. 20B becomes less observable when the minimum transmittance is 85% or more, and naturally, it becomes further less observable when the minimum transmittance is 90% or more.

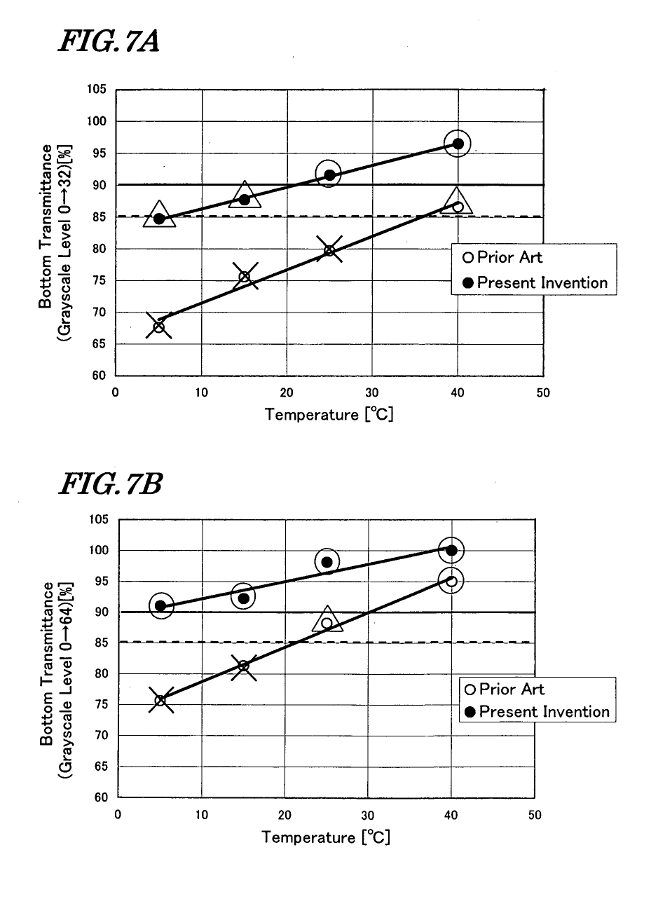

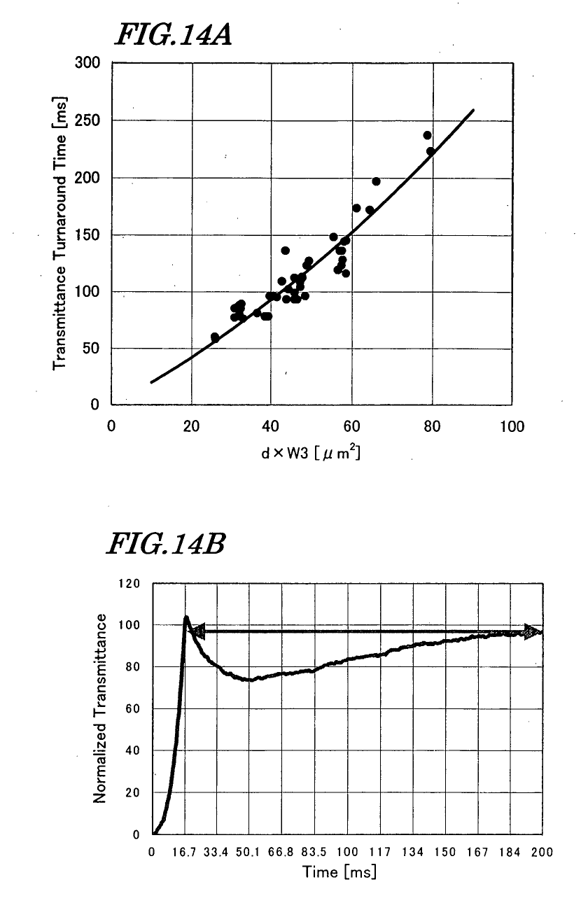

Prototypes of 13-inch VGA LCDs were actually fabricated, and subjective evaluation was conducted by 25 persons on the effect of improvement of the response characteristic of the LCD. The results are shown in FIGS. 7A and 7B together with those of a conventional LCD. The 13-inch VGA LCDs (LCD of the invention and the conventional LCD) used in this evaluation are the same as LCDs that present the results shown in FIGS. 14A to 14C to be described later. The OS driving conditions are also the same as those to be described later. Hereinafter, the effect obtained by increasing the minimum transmittance to 85% or more, or 90% or more, will be described.

In the graphs shown in FIGS. 7A and 7B, the x-axis represents the temperature of the display plane of the LCD (this temperature is referred to as the “operating temperature”), and the y-axis represents the minimum transmittance given when OS driving is done. With change of the operating temperature of the LCD, the properties of the liquid crystal material such as the viscosity change, and this leads to change of the response characteristic of the LCD. The response characteristic degrades with fall of the operating temperature, and improves with rise of the operating temperature. In this measurement, the operating temperature was set at 5° C., 15° C., 25° C. and 40° C. The OS driving-caused horn response more easily occurs as the shift in display grayscale level is smaller. FIG. 7A shows the results observed when the display grayscale level is shifted from 0 to 32 (when a square of grayscale level 0 is moved in a background of grayscale level 32), and FIG. 7B shows the results observed when the display grayscale level is shifted from 0 to 64 (when a square of grayscale level 0 is moved in a background of grayscale level 64). The symbols (∘, Δ, ×) overlapping the points in FIGS. 7A and 7B show the results of the subjective evaluation. While a dark belt like the dark belt 92b shown in FIG. 20B is observed under the influence of horn response, the symbol ∘ indicates that almost all the observers hardly visually recognized such a dark belt, the symbol Δ indicates that some observers visually recognized the dark belt but were little annoyed with this, and the symbol × indicates that almost all the observers visually recognized the dark belt.

As is found from FIGS. 7A and 7B, the results of the subjective evaluation are Δ or ∘ when the minimum transmittance is 85% or more, and they are ∘ when the minimum transmittance is 90% or more. In the conventional LCD, in the case of the shift of the grayscale level from 0 to 32 (FIG. 7A), it is only when the operating temperature is 40° C. that the minimum transmittance reaches 85% or more. The minimum transmittance is only around 80% with the subjective evaluation of × at 25° C. that is a temperature generally used (room temperature). On the contrary, in the LCD of the invention, in the case of the shift of the grayscale level from 0 to 32 (FIG. 7A), the minimum transmittance is 85% or more even when the operating temperature is 5° C., and it is 90% or more at an operating temperature of 25° C. or more. In the case of the shift of the grayscale level from 0 to 64 (FIG. 7B), a minimum transmittance of 90% or more can be obtained even at an operating temperature of 5° C.

As described above, the minimum transmittance can be 85% or more by setting the LC region width W3 at about 14 μm or less, or the minimum transmittance can be 90% or more by setting the LC region width W3 at about 12 μm or less. With such a minimum transmittance, the resultant MVA LCD is excellent in moving image display characteristics in which a dark belt is less or hardly recognizable even when OS driving is done.

In the currently available nine models of MVA LCDs (two manufactures, panel size: 15 to 37 inches), the LC region width W3 is in the range between about 15 μm and about 25 μm (the rib width W1 is in the range between about 9 μm and about 15 μm, the slit width W2 is in the range between about 9 μm and about 10 μm, and the LC region width W3/slit width W2 is in the range between about 1.5 and about 2.6). According to the results described above (in FIG. 6, for example), a dark belt will be observed in these LCDs if OS driving is done as in this embodiment.

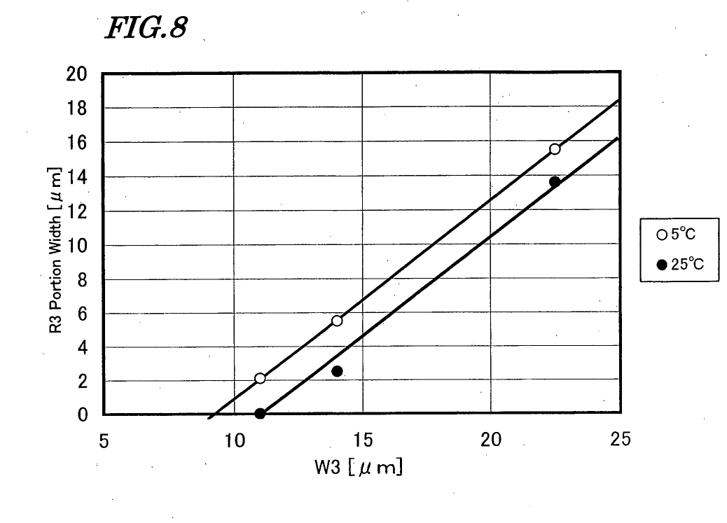

The reason why the response characteristic is improved by reducing the LC region width W3 will be described with reference to FIGS. 8 and 4.

FIG. 8 is a graph showing the relationship between the LC region width W3 and the width of the third LC portion R3. As described above with reference to FIG. 4, the third LC portion R3 is a portion of the liquid crystal region 13A located apart from both the rib 21 and the slit 22 and thus lowest in response speed.

Herein, the third LC portion R3 is defined as follows to enable quantitative expression of the width of the portion R3. That is, the third LC portion R3 is defined as a portion of the liquid crystal region in which the transmittance reached in one frame after application of an OS voltage (OSV32) with which the state of display of grayscale level 0 (black display state) is shifted to grayscale level 32 is twice or less the transmittance in the black display state. A change in transmittance distribution with time was measured as in FIG. 4 for LCDs different in LC region width W3, and the width of the third LC portion R3 determined according to the above definition was obtained for each LCD. The results were blotted as the graph of FIG. 8. FIG. 8 shows the measurement results at 25° C. and 5° C.

The graph of FIG. 8 includes two straight lines having the same inclination, indicating that the widths of the first LC portion R1 and the second LC portion R2 are constant irrespective of the LC region width W3. Thus, the relationship that R3 width=LC region width W3−R1 width−R2 width is established. The third LC portion R3 will no more substantially exist if the response characteristic of the liquid crystal region 13A improves. Even in this case, however, it is possible to determine the width of the third LC portion R3 as a negative value from the graph (straight line) of FIG. 8. This width of the third LC portion R3 can therefore be used as a parameter representing the response characteristic of the liquid crystal region 13A.

As is found from FIG. 8, at 25° C., the width of the third LC portion R3 is zero when the LC region width W3 is about 12 μm or less. That is, the third LC portion R3 low in response speed defined as described above substantially disappears. This corresponds to the LC region width W3 giving a minimum transmittance of 90% or more in FIG. 6, exhibiting good correlation therebetween.

In the results obtained at 5° C. shown in FIG. 8, the width of the third LC portion R3 is zero when the LC region width W3 is about 8 μm or less. It is therefore found that the LC region width W3 is preferably about 8 μm or less to ensure more excellent response characteristic (moving image display characteristics).

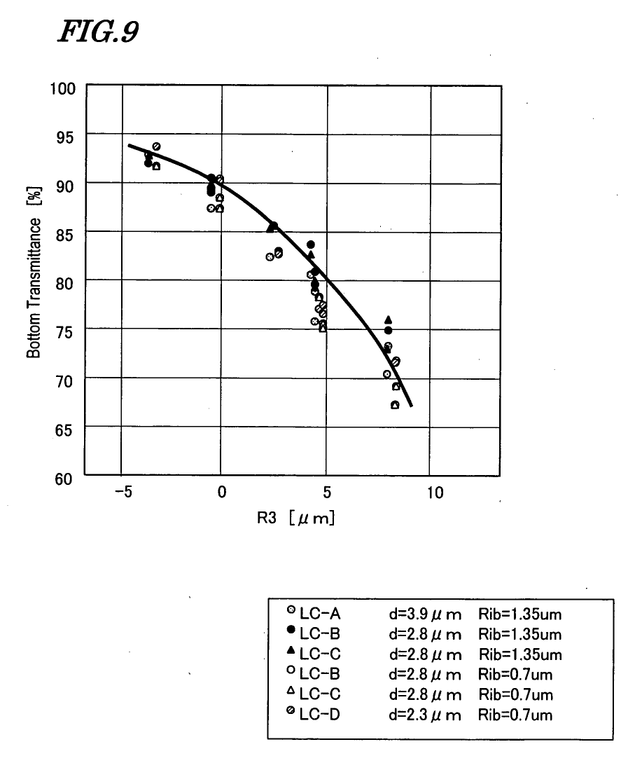

FIG. 9 is a graph re-plotted from the graph of FIG. 6 with respect to the width of the third LC portion R3. As is found from FIG. 9, the minimum transmittance can be 85% or more by reducing the width of the third LC portion R3 to about 2 μm or less, or it can be 90% or more by reducing the width of R3 to about 0 μm or less.

As described above, by reducing the LC region width W3, the response characteristic can be improved, and thus the minimum transmittance in horn response (see FIGS. 5A and 5B) occurring when OS driving is done can be increased to 85% or more of a predetermined transmittance. With this improvement, the phenomenon caused by the horn response is hardly observed, and thus an LCD permitting good moving image display is provided.

It is difficult to fabricate an LCD having an LC region width W3 below 2 μm. Therefore, the LC region width W3 is preferably 2 μm or more, and also, for the same reason, the rib width W1 and the slit width W2 are preferably 4 μm or more.

The OS driving method adopted for the LCD of the invention is not specifically limited, but any known OS driving method may be adopted. Setting of the OS voltage may be made as follows, for example. While the OS voltage is set so that a predetermined transmittance is reached within one vertical scanning period in the shift of the display grayscale level every 32 levels (for example, from V0 to V32) as described above, the OS voltage to be applied in a shift of the grayscale level by less than 32 levels may be determined by interpolation using OS voltage values determined for the shift every 32 grayscale levels. The OS voltage may be changed according to the grayscale levels before and after the shift. Otherwise, as described in Literature 2 mentioned above, no OS voltage may be applied for a shift between some grayscale levels.

In this embodiment, the OS voltage value with which a predetermined transmittance was reached after one frame period was determined every 32 grayscale levels, and an OS voltage value corresponding to each shift of grayscale levels within each 32 levels was obtained by interpolation using the determined OS voltage values. Using the thus-obtained OS voltages, the MVA LCD of this embodiment having an LC region width W3 of 14 μm or less was driven. As a result, good moving image display was attained.

Next, the aperture ratio and transmittance of the MVA LCD of this embodiment will be described. As is found from FIGS. 2 and 3, reducing the LC region width W3 means lowering the aperture ratio ((pixel area−rib area−slit area)/pixel area) and thus lowering the display luminance. Therefore, if the spacing between the alignment regulating means (that is, the LC region width W3) is uniformly reduced to improve the response characteristic, the aperture ratio will decrease. To avoid this problem, in Literature 1 mentioned above (see FIG. 107, for example), for example, while the spacing between the adjacent alignment regulating means is narrowed in a certain portion of one pixel, it is made wide in the remaining portion of the pixel, to thereby achieve improvement of the response characteristic without lowering the aperture ratio. However, for the reason described above, having both narrow and wide portions as the spacing between the alignment regulating means will result in formation of portions largely different in response speed (in particular, result in increase of the area of the portion low in response speed), as described in Literature 1. This will make the problem of horn response significant.

According to the basic configuration of the LCD of the embodiment of the present invention shown in FIGS. 2 and 3, the spacing between the ribs 21 and the slits 22 (that is, the width W3 of the stripe-shaped liquid crystal region 13A) is set in the range described above, and thus occurrence of the problem of horn response can be suppressed. Also, although the liquid crystal regions 13A are uniform in width in one pixel in the illustrated example, liquid crystal regions 13A different in the width W3 may be formed in one pixel in some cases due to a cause related to the fabrication process (for example, an alignment error in the process of bonding of the substrates). In such an occurrence, however, as long as the widths W3 of respective liquid crystal regions 13A satisfy the above condition, occurrence of the problem of horn response can be suppressed.

Moreover, it was clarified from the examinations conducted in relation to the present invention that the MVA LCD of this embodiment could keep its display luminance from lowering despite the reduction of the LC region width W3 from the width conventionally used. This is thanks to an unexpected effect that the transmittance per unit area of a pixel (hereinafter, called the “transmission efficiency”) improves by reducing the LC region width W3 from the conventional width. The transmission efficiency is determined by actually measuring the transmittance of a pixel and dividing the measured value by the aperture ratio ((pixel area−rib area−slit area)/pixel area)). Herein, the transmission efficiency is expressed by a value somewhere between 0 and 1.

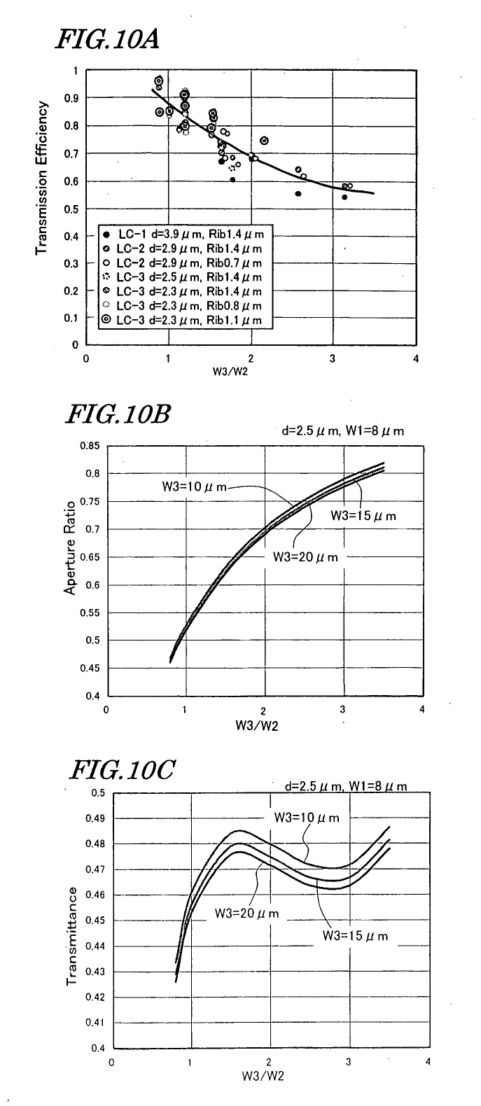

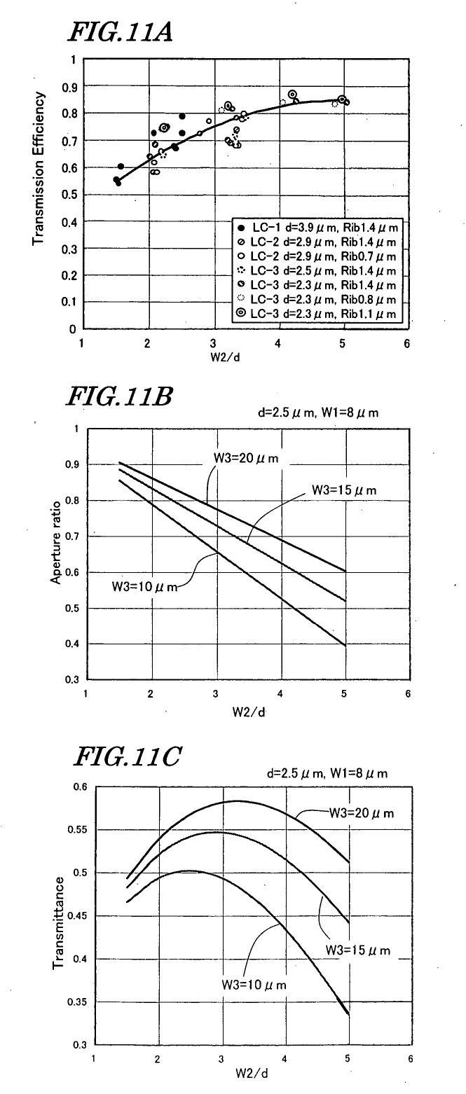

Prototypes of 13-inch VGA LCDs were fabricated, and part of the results of examination on the relationship between various cell parameters described above (the thickness d of the liquid crystal layer, the rib width W1, the slit width W2, the LC region width W3, the rib height and the like) and the transmission efficiency are shown in FIGS. 10A through 10C and 11A through 11C. The prototypes of 13-inch VGA LCDs shown in the following description include ones different from the LCDs subjected to the subjective evaluation described above.

FIGS. 10A to 10C are graphs of which the x-axis represents the LC region width W3/slit width W2, and the y-axis represents the transmission efficiency (FIG. 10A), the aperture ratio (FIG. 10B) and the transmittance (the absolute transmittance obtained when the highest grayscale voltage V255 is applied in static driving) (FIG. 10C), respectively. FIGS. 11A through 11C are graphs of which the x-axis represents the slit width W2/thickness d of the liquid crystal layer, and the y-axis represents the transmission efficiency (FIG. 11A), the aperture ratio (FIG. 11B) and the transmittance (the absolute transmittance obtained when the highest grayscale voltage V255 is applied in static driving) (FIG. 11C), respectively. LC-1, 2 and 3 in FIGS. 10A and 11A represent the kinds of liquid crystal materials used, d denotes the thickness of the liquid crystal layer (cell gap), and “rib” denotes the rib height. As the liquid crystal materials, selected were those having a rotational viscosity γ1 of about 140 mPa·s and a flow viscosity ν of about 20 mm²/s and giving a retardation (thickness d×birefringence Δn) of the liquid crystal layer of about 300 nm.

As is found from FIG. 10A, as the LC region width W3/slit width W2 is smaller, the transmission efficiency improves. The LC region width W3/slit width W2 of the currently available MVA LCDs is about 1.5 or more and the transmission efficiency thereof is about 0.7 or less as described above. By setting the LC region width W3/slit width W2 to be less than 1.5, transmission efficiency exceeding 0.7 can be obtained.

FIG. 10B is a graph showing the relationship between the LC region width W3/slit width W2 and the aperture ratio, for LCDs having the thickness d of the liquid crystal layer of 2.5 μm, the rib width W1 of 8 μm and the LC region width W3 of 10, 15 and 20 μm. As is found from this graph, naturally, as the LC region width W3/slit width W2 is smaller, the aperture ratio decreases. Thus, as the aperture ratio decreases, the transmission efficiency increases. This is an unexpected phenomenon. However, it is useless to increase the transmission efficiency if the display luminance, that is, the transmittance decreases even though the transmission efficiency improves. In view of this, the relationship between the LC region width W3/slit width W2 and the transmittance will be described with reference to FIG. 10C.

FIG. 10C is a graph showing the relationship between the LC region width W3/slit width W2 and the transmittance (absolute transmittance) for the same LCDs as those used for FIG. 10B. The transmission efficiency shown in FIG. 10A is obtained By dividing the value of the transmittance shown in FIG. 10C by the value of the aperture ratio shown in FIG. 10B.

As is found from FIG. 10C, the transmittance is highest when the LC region width W3/slit width W2 is about 1.5, and decreases both as W3/W2 exceeds about 1.5 and as it decreases to less than about 1.5. In the embodiment of the present invention, improvement in transmission efficiency is obtained by setting the LC region width W3/slit width W2 to be less than about 1.5. On the contrary, the currently available MVA LCDs have the LC region width W3/slit width W2 in the range between 1.5 and 2.6 (W3 is about 15 μm or more). To set the LC region width W3/slit width W2 to be less than about 1.5 and yet secure the same level of transmittance as that conventionally attained, the LC region width W3/slit width W2 is preferably not less than 1.0, and preferably 1.1 or more. If the LC region width W3/slit width W2 is less than 1.0, the reduction in aperture ratio is more dominant than the effect of increasing the transmission efficiency, and thus the transmittance abruptly falls with decrease of the LC region width W3/slit width W2 as shown in FIG. 10C.

From the results described above, it is found that the horn response can be suppressed by setting the LC region width W3 in the range between 2 μm and 14 μm. Also found is that it is possible to secure the same level of transmittance (display luminance) as that conventionally obtained while improving the transmission efficiency by setting the LC region width W3/slit width W2 in the range between 1.0 and less than 1.5. Also, as is found from FIG. 10c, when the LC region width W3/slit width W2 is roughly the same, the transmittance is higher as the LC region width W3 is smaller. Setting the LC region width W3 at 14 μm or less suppresses the horn response and moreover contributes to improvement in transmittance. In addition, as will be described later, increase in transmission efficiency is an effect obtained when the alignment of liquid crystal molecules is stabilized. Hence, if an equal transmittance is obtained, or even if the transmittance is somewhat sacrificed, it is considered preferred to place more importance on the transmission efficiency than on the aperture ratio.

Next, the effect of the slit width W2/thickness d of the liquid crystal layer on the transmission efficiency will be described.

As is found from FIG. 11A, as the slit width W2/thickness d of the liquid crystal layer (W2/d) increases, the transmission efficiency increases. Specifically, the transmission efficiency is about 0.7 or more when W2/d is about 3 or more. It is further recognized that the transmission efficiency tends to be stable at values as high as about 0.8 or more when W2/d is 4 or more.

The aperture ratio monotonously decreases as W2/d increases as shown in FIG. 11B. The transmittance has a maximum with respect to W2/d as shown in FIG. 1C. In other words, although the aperture ratio decreases at the expense of increase of the transmission efficiency with increase of W2/d, there exists a range in which the transmittance increases. The maximum of the transmittance, which varies with the LC region width W3, is reached when W2/d is in the range between 2.5 and 3.5.

The results shown in FIGS. 11B and 11C are for the LCDs having the thickness d of the liquid crystal layer of 2.5 μm, the rib width W1 of 8 μm and the LC region width W3 of 10, 15 and 20 μm. However, the range in which the transmittance increases due to the contribution of the effect that the transmission efficiency increases with increase of W2/d irrespective of the thickness d2 of the liquid crystal layer and the rib width W1 is limited. In general, the cell parameters for maximizing the transmittance do not agree with the cell parameters for maximizing the transmission efficiency. Therefore, on which importance should be placed, the transmittance or the transmission efficiency, may be determined appropriately depending on the use of the LCD and the like. The transmission efficiency is one indicator representing the proportion of the liquid crystal molecules that tilt in predetermined directions under the influence of the alignment regulating forces of the slits and the ribs, in relation to the liquid crystal molecules in the liquid crystal layer contributing to display (that is, the liquid crystal molecules existing in the aperture regions). To improve the display characteristics including the moving image display performance described above, it is important to have high transmission efficiency. Hence, from the results shown in FIG. 11A, it is preferred to have the slit width W2/thickness d of the liquid crystal layer of 4 or more to obtain transmission efficiency as high as 0.8 or more.

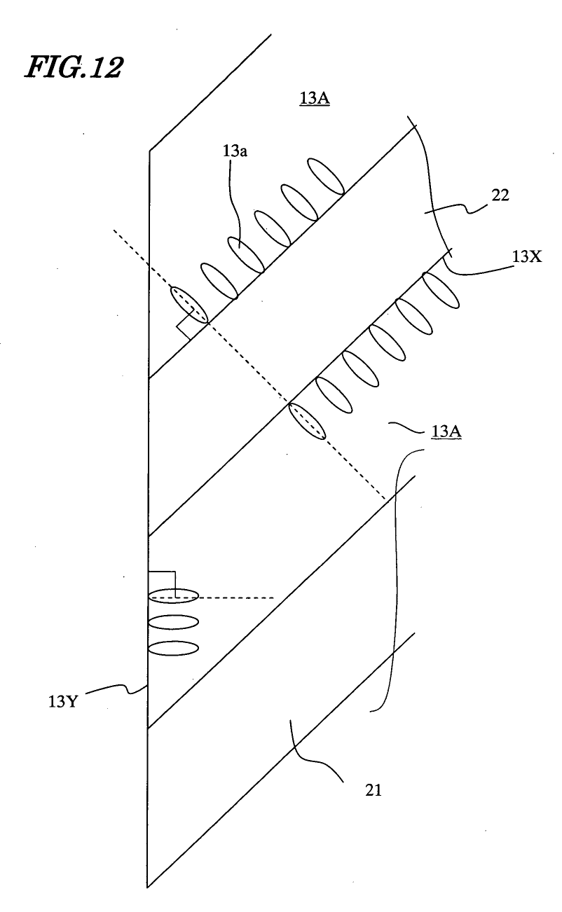

The reason why the transmission efficiency improves by reducing the LC region width W3 as shown in FIG. 10A will be discussed with reference to FIG. 12. FIG. 12 diagrammatically shows how liquid crystal molecules 13a located near the slit 22 in the liquid crystal region 13A are aligned. Among the liquid crystal molecules 13a in the liquid crystal region 13A, those located near a side (longer side) 13X of the stripe-shaped liquid crystal region 13A tilt in the plane perpendicular to the side 13X under the influence of a tilt electric field. On the contrary, liquid crystal molecules 13a located near a side (shorter side) 13Y of the liquid crystal region 13A intersecting the side 13X tilt in a direction different from the direction of the tilt of the liquid crystal molecules 13a near the side 13X, under the tilt electric field. In other words, the liquid crystal molecules 13a located near the side 13Y of the liquid crystal region 13A tilt in a direction different from a predetermined alignment direction defined by the alignment regulating force of the slit 22, acting to disturb the alignment of the liquid crystal molecules 13a in the liquid crystal region 13A. By reducing the width W3 of the liquid crystal region 13A (that is, reducing the value of (length of longer side/length of shorter side)), the proportion of the liquid crystal molecules 13a that tilt in the predetermined direction under the influence of the alignment regulating force of the slit 22, in relation to all the liquid crystal molecules 13a in the liquid crystal region 13A, increases, resulting in increase of the transmission efficiency. In this way, by reducing the LC region width W3, obtained is the effect of stabilizing the alignment of the liquid crystal molecules 13a in the liquid crystal region 13A, and as a result, the transmission efficiency improves.

As described with reference to FIG. 11A, the reason why the transmission efficiency increases with increase of the slit width W2/thickness d of the liquid crystal layer increases is that the alignment stabilizing effect (effect of improving the transmission efficiency) obtained with decrease in LC region width W3 is exhibited significantly when the thickness d of the liquid crystal layer is small, for example, as small as less than 3 μm. As the thickness d of the liquid crystal layer is smaller, the action of the tilt electric field from the slit 22 is more intense. However, at the same time, the liquid crystal layer is more affected by the electric field from gate bus lines and source bus lines placed in the vicinity of the pixel electrode 12, or the electric field from adjacent pixel electrodes. These electric fields act to disturb the alignment of the liquid crystal molecules 13a in the liquid crystal layer 13A. Therefore, it is considered that the alignment stabilizing effect described above is exhibited significantly in the case that the thickness d of the liquid crystal layer is small in which the alignment of the liquid crystal molecules 13a tend to be disturbed.

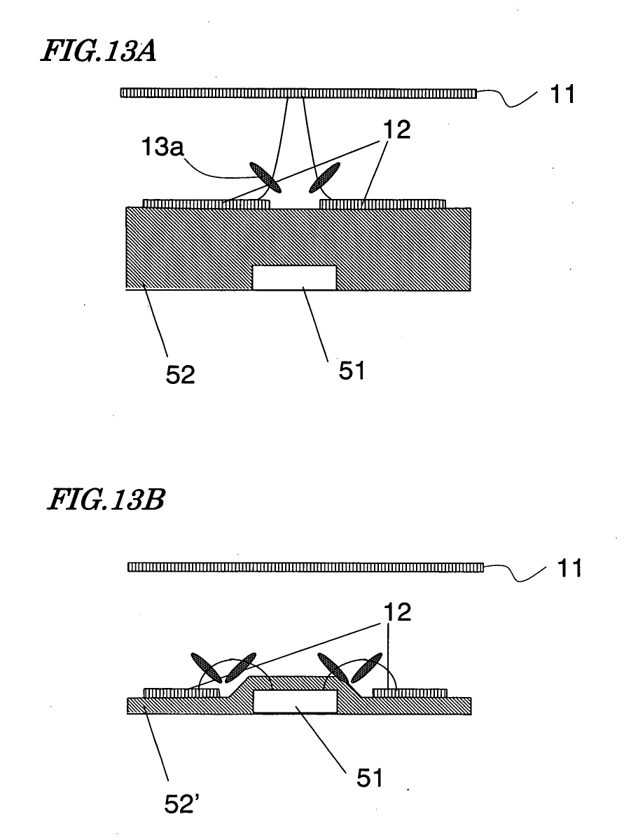

The LCD exemplified in this embodiment includes the comparatively thick interlayer insulating film 52 covering the gate bus lines and the source bus lines, and the pixel electrode 12 is formed on the interlayer insulating film 52, as shown in FIG. 2. The influence of the interlayer insulating film 52 on the alignment of the liquid crystal molecules 13a will be described with reference to FIGS. 13A and 13B.

As shown in FIG. 13A, the interlayer insulating film 52 of the LCD of this embodiment is comparatively thick (for example, the thickness is in the range between about 1.5 μm and about 3.5 μm). Therefore, even if the pixel electrode 12 and the gate bus line or the source bus line 51 overlap each other via the interlayer insulating film 52 therebetween, a capacitance formed therebetween is too small to give an influence on the display quality. Also, the alignment of the liquid crystal molecules 13a existing between the adjacent pixel electrodes 12 is mostly influenced by the tilt electric field generated between the counter electrode 11 and the pixel electrodes 12, as diagrammatically shown by the electric lines of force in FIG. 13A, and hardly influenced by the source bus line 51.

On the contrary, as diagrammatically shown in FIG. 13B, when a comparatively thin interlayer insulating film 52′ (for example, an SiO₂ film having a thickness of several hundred nanometers) is formed, a comparatively large capacitance will be formed if the source bus line 51, for example, and the pixel electrode 12 overlap each other via the interlayer insulting film 52′ therebetween, resulting in degradation of the display quality. To prevent this problem, as shown in FIG. 12B, arrangement is made to avoid overlap between the pixel electrode 12 and the source bus line 51. In this arrangement, the liquid crystal molecules 13a existing between the adjacent pixel electrodes 12 are largely influenced by the electric field generated between the pixel electrodes 12 and the source bus line 51, as shown by the electric lines of force in FIG. 13B, resulting in disturbance of the alignment of the liquid crystal molecules 13a located at the ends of the pixel electrodes 12.

As is apparent from comparison between FIGS. 13A and 13B, by providing the comparatively thick interlayer insulating film 52 as in the exemplified LCD of this embodiment, the liquid crystal molecules 13a are substantially free from the influence of the electric field from the gate bus lines/source bus lines, and thus can be advantageously aligned favorably in a desired direction with the alignment regulating means. In addition, since the influence of the electric field from the bus lines is minimized with the comparatively thick interlayer insulating film 52, the alignment stabilizing effect obtained by reducing the thickness of the liquid crystal layer can be exhibited significantly.

To intensify the alignment regulating force of the slit 22, an electrode having a different potential from the electrode in which the slit 22 is formed (for example, a storage capacitor electrode when the slit is formed in the pixel electrode) may be placed on the lower face of the slit 22 (face opposite to the liquid crystal layer 13).

From the standpoint of the response characteristic, the thickness d of the liquid crystal layer 13 is preferably small (see FIGS. 5A and 5B, for example). By setting the thickness d of the liquid crystal layer 13 at less than 3 μm in the LCD having the configuration described above, an MVA LCD permitting further high-definition moving image display can be provided.

The reason why the response characteristic is improved by reducing the thickness d of the liquid crystal layer 13 will be described with reference to FIGS. 14A and 14B.

In the graph of FIG. 14A, the x-axis represents the product of the width W3 of the liquid crystal region 13A and the thickness d of the liquid crystal layer 13, and the y-axis represents the transmittance turnaround time. The definition of the “transmittance turnaround time” as used herein will be described with reference to FIG. 14B. As described above, in OS driving, the transmittance changes with time as diagrammatically shown in FIG. 14B. Specifically, with application of an OS voltage (at time of 0 ms), the transmittance reaches a predetermined value after one frame (at time of 16.7 ms) and then decreases to a minimum. Thereafter, the transmittance gradually increases to be close to a value corresponding to a predetermined grayscale voltage. In this change of the transmittance, the time length from the time (16.7 ms) of the first reach to the predetermined transmittance to the time of reach to 99% of the predetermined transmittance via the minimum is called the “turnaround time”. Note that the results illustrated are those obtained when the display grayscale is shifted from 0 to 32.

As is found from FIG. 14A, as (d×W3) is smaller, the transmittance turnaround time is shorter, exhibiting a more excellent response characteristic. The LC region width W3 is preferably set at 14 μm or less as described above. In this case, if the thickness d of the liquid crystal layer is set at less than 3 μm, the transmittance turnaround time will be about 100 ms or less.

As described above, by setting the LC region width W3 at 14 μm or less and the thickness d of the liquid crystal layer at less than 3 μm, occurrence of the problem related to the horn response can be suppressed, and further the response characteristic can be improved.

A prototype of 13-inch VGA LCD was actually fabricated as described above, and the moving image display performance thereof was evaluated. The evaluation results are as follows. As the cell parameters, substantially the same values as those exemplified for the LCD 100 shown in FIG. 4 were used, except that thickness d of the liquid crystal layer was set at 2.5 μm and the LC region width W3 was set at 10.7 μm in this case. For comparison, the characteristics of a conventional LCD of which the thickness d of the liquid crystal layer was 3.4 μm and the LC region width W3 was 15.4 μm were also evaluated.

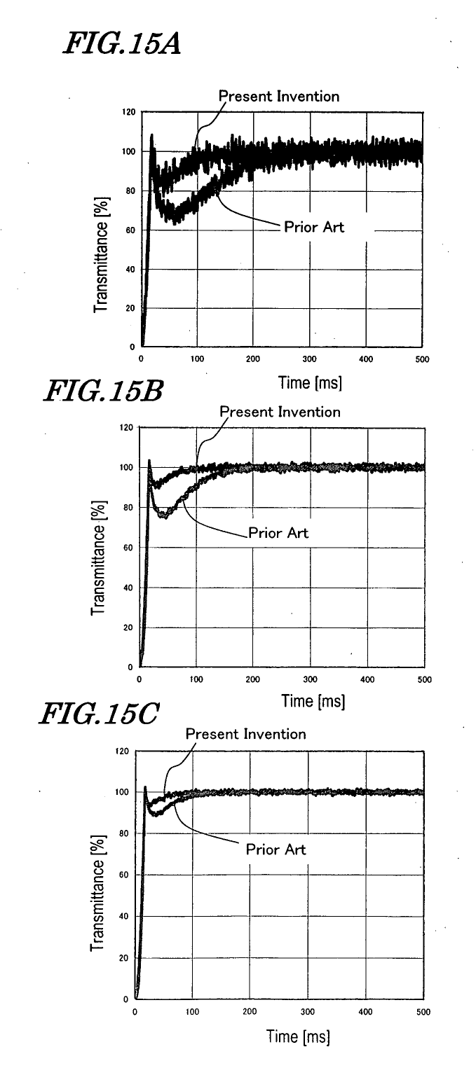

FIGS. 15A through 15C show the results of evaluation of the change with time (horn response characteristic) of the entire transmittance of the pixel portion for the LCD of the invention and the conventional LCD. Specifically, FIGS. 15A through 15C show the horn response characteristic observed when the grayscale display is shifted from 0 to 32 (FIG. 15A), from 0 to 64 (FIG. 15B) and from 0 to 96 (FIG. 15C). Note that OS driving was done for both the LCD of the invention and the conventional LCD, and that the operating temperature was 5° C.

As is found from FIGS. 15A through 15C, in the LCD of the invention, in which the response characteristic has been improved, the minimum transmittance is higher than in the conventional LCD in any of the above cases, achieving 80% or more of the transmittance corresponding to a predetermined grayscale level. In addition, as a result of subjective evaluation performed in the manner described above, while a dark belt was observed when OS driving was done for the conventional LCD, a dark belt was hardly recognized when OS driving was done for the LCD of the invention.

Hereinafter, the specific conditions of the OS driving and the response characteristic for the LCD of the invention and the conventional LCD will be described with reference to Tables 1 to 6 below. Note that Tables 1 to 6 show the results obtained at 5° C.

In each of Tables 1 to 6, the value at the left end (start) indicates the display grayscale level in the initial state, and the values in the upper row (end) indicate the display grayscale levels after the rewrite. Herein, the case that the display grayscale level in the initial state is 0 will be described.

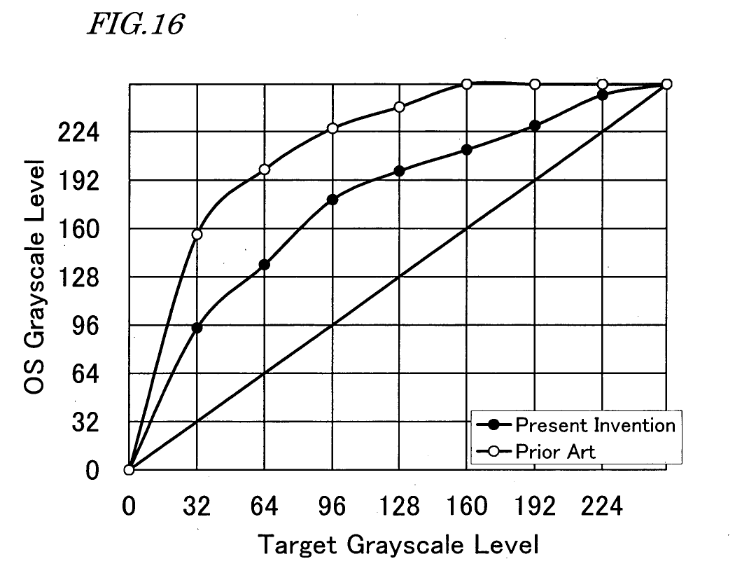

The OS voltage values (herein indicated by the corresponding display grayscale levels) are set as shown in Table 1 for the LCD of the invention and in Table 4 for the conventional LCD. For example, as shown in Table 1, for the shift of display from grayscale level 0 to 32, a voltage value corresponding to grayscale level 94 was applied as the OS voltage. As for grayscale levels that are not shown in Tables 1 and 4, a graph shown in FIG. 16 was prepared based on the relationship set in Tables 1 and 4, to obtain corresponding OS grayscale levels by interpolation.

Tables 2 and 3 show the response times required when no OS driving is done and when OS driving is done, respectively, for the LCD of the invention. Likewise, Tables 5 and 6 show the response times required when no OS driving is done and when OS driving is done, respectively, for the conventional LCD. The response time used in this measurement refers to the time (unit: msec) required for a transmittance to change from 10% to 90% when the change of a predetermined transmittance in each shift in grayscale level is from 0% to 100%.

As shown in Tables 1 and 4, the OS voltage was set every 32 grayscale levels so that a predetermined grayscale level was reached within one frame period. For example, as shown in Table 1 for the LCD of the invention, the OS voltage for the shift of the grayscale level from 0 to 32 (OSV32) was set at V94 (voltage corresponding to grayscale level 94). This indicates that V94 was applied in place of V32 to be applied in the normal driving. For the conventional LCD, as shown in Table 4, the OS voltage for the shift of the grayscale level from 0 to 32 (OSV32) was set at V156 (voltage corresponding to grayscale level 156). The reason why the OS voltage value is higher in the conventional LCD is that the LCD of the invention is more excellent in response characteristic (shorter in response time) as is apparent from comparison between Tables 2 and 5. From these tables, also, it is proved that the configuration described above improves the response characteristic.

As is found from the response time shown in Table 2, in the LCD of the invention, the response time tends to be longer than one frame period (16.7 msec) in display of low grayscale levels when no OS driving is done. With OS driving, however, the response time can be made shorter than one frame period for all the grayscale levels as shown in Table 3. In addition, the problem of horn response does not occur as described above. On the contrary, when OS driving is done for the conventional LCD, the response time is greatly improved as shown in Table 6, but is still longer than one frame period in some cases, and moreover the problem of horn response occurs as described above.

TABLE 1
OS amount

| | end | | | | | | | | |
|---|---|---|---|---|---|---|---|---|---|
| | 0 | 32 | 64 | 96 | 128 | 160 | 192 | 224 | 255 |
| 0 | 0 | 94 | 136 | 179 | 198 | 212 | 228 | 248 | 255 |

TABLE 2
(Without OS, 10-90%)

| | end | | | | | | | | |
|---|---|---|---|---|---|---|---|---|---|
| | 0 | 32 | 64 | 96 | 128 | 160 | 192 | 224 | 255 |
| 0 | | 99.5 | 69.6 | 57.5 | 43.5 | 34.8 | 27.1 | 16.6 | 15.5 |

TABLE 3
(With OS, 10-90%)

| | end | | | | | | | | |
|---|---|---|---|---|---|---|---|---|---|
| | 0 | 32 | 64 | 96 | 128 | 160 | 192 | 224 | 255 |
| 0 | | 11.5 | 10.3 | 10.6 | 10.2 | 10.3 | 10.0 | 8.3 | 15.5 |

TABLE 4
OS amount

| | end | | | | | | | | |
|---|---|---|---|---|---|---|---|---|---|
| | 0 | 32 | 64 | 96 | 128 | 160 | 192 | 224 | 255 |
| 0 | 0 | 156 | 199 | 226 | 240 | 255 | 255 | 255 | 255 |

TABLE 5
(Without OS, 10-90%)

| | end | | | | | | | | |
|---|---|---|---|---|---|---|---|---|---|
| | 0 | 32 | 64 | 96 | 128 | 160 | 192 | 224 | 255 |
| 0 | | 212.7 | 143.6 | 94.9 | 69.3 | 48.7 | 35.4 | 26.1 | 28.1 |

TABLE 6
(With OS, 10-90%)

| | end | | | | | | | | |
|---|---|---|---|---|---|---|---|---|---|
| | 0 | 32 | 64 | 96 | 128 | 160 | 192 | 224 | 255 |
| 0 | | 11.6 | 9.4 | 9.0 | 9.4 | 14.5 | 29.2 | 33.8 | 28.1 |

As described above, the LCD of the invention exhibits excellent moving image display characteristics by adopting OS driving. Therefore, with further provision of a circuit for receiving television broadcast, the LCD can be suitably used as an LCD TV permitting high-definition moving image display. To attain the OS driving, known methods may be broadly adopted. A drive circuit adapted to apply an OS voltage higher than a grayscale voltage determined in advance to correspond to a predetermined grayscale level (or possibly apply the grayscale voltage) may further be provided. Otherwise, the OS driving may be executed by software.

In the above embodiment, the present invention was described as adopting OS driving. There is also a case that a voltage is applied in a similar way (for example, the display signal voltage is applied in the order of V0→V94→V32) although no OS driving is adopted. In such a case, also, the effect of the present invention can be obtained.

According to the present invention, the response characteristic of alignment-divided vertical alignment LCDs having a large viewing angle characteristic is improved, and thus LCDs permitting high-definition moving image display are provided. In addition, in the alignment-divided vertical alignment LCDs of the present invention, in which the width of liquid crystal regions formed between the adjacent ribs and slits is made smaller (the aperture ratio is made smaller) than the conventional ones, reduction in display luminance that may result from the improvement in moving image display performance can be suppressed because liquid crystal molecules can be aligned more efficiently (the proportion of liquid crystal molecules subjected to alignment regulating force is increased). The LCDs of the present invention find various applications such as TVs.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This non-provisional application claims priority under 35 USC § 119(a) on Patent Application No. 2004-064223 filed in Japan on Mar. 8, 2004, the entire contents of which are hereby incorporated by reference. In addition, the entire contents of non-provisional application Ser. No. 10/898,688 filed on Jul. 26, 2004 are hereby incorporated by reference.

1. A liquid crystal display device having a plurality of pixels each having a first electrode, a second electrode facing the first electrode, and a vertically aligned liquid crystal layer placed between the first and second electrodes, the device comprising:
ribs in a stripe shape having a first width placed in the first electrode side of the liquid crystal layer;
slits in a stripe shape having a second width placed in the second electrode side of the liquid crystal layer; and
liquid crystal regions having a third width defined between the ribs and the slits,
wherein the third width is in a range between 2 μm and 14 μm, and the ratio of the third width to the second width is in a range between 1.0 and less than 1.5.

2. The device of claim 1, wherein the ratio of the second width to the thickness of the liquid crystal layer is 4 or more.

3. The device of claim 1, wherein the third width is 12 μm or less.

4. The device of claim 3, wherein the third width is 8 μm or less.

5. The device of claim 1, wherein the first width is in a range between 4 μm and 20 μm, and the second width is in a range between 4 μm and 20 μm.

6. The device of claim 1, wherein the thickness of the liquid crystal layer is less than 3 μm.

7. The device of claim 1, further comprising a pair of polarizing plates placed to face each other with the liquid crystal layer therebetween, transmission axes of the pair of polarizing plates are orthogonal to each other, one of the transmission axes extends in a horizontal direction in the display plane, and the ribs and the slits are placed to extend in a direction about 45° from the one of the transmission axes.

8. The device of claim 1, further comprising a drive circuit capable of applying an overshoot voltage higher than a grayscale voltage determined in advance to correspond to a predetermined grayscale.

9. Electronic equipment comprising the liquid crystal display device of claim 1.

10. The electronic equipment of claim 9, further comprising a circuit for receiving television broadcast.
